(19) United States
(12) Patent Application Publication
(10) Pub. No.: US 2024/0042808 A1
(43) Pub. Date: Feb. 8, 2024

(54) SOUND-ABSORBING MATERIAL FOR TIRES

(71) Applicants: Hyundai Motor Company, Seoul (KR); Kia Corporation, Seoul (KR); NEXEN TIRE CORPORATION, Gyeongsangnam-do (KR); KUMHO TIRE CO., INC, Gwangju (KR)

(72) Inventors: Yong Tae Joo, Uiwang (KR); Seung Ho Hyun, Gyeonggi-do (KR); Hee Kyu Lim, Suwon (KR); Seung Won Kim, Gyeonggi-do (KR)

(21) Appl. No.: 18/080,532

(22) Filed: Dec. 13, 2022

(30) Foreign Application Priority Data
Aug. 3, 2022 (KR) 10-2022-0096443

(51) Int. Cl. B60C 19/00

(52) U.S. Cl. CPC B60C 19/002

(57) ABSTRACT

Disclosed is a sound-absorbing material for tires having an excellent cavity noise reduction effect and capable of minimizing the rate of absorption of liquid latex.

### CROSS-REFERENCE TO RELATED APPLICATION

This application claims, under 35 U.S.C. § 119(a), the benefit of priority from Korean Patent Application No. 10-2022-0096443, filed on Aug. 3, 2022, the entire contents of which are incorporated herein by reference.

### TECHNICAL FIELD

The present disclosure relates to a sound-absorbing material for tires, which can exhibit an excellent cavity noise reduction effect and minimize the rate of absorption of liquid latex.

### BACKGROUND

In order to reduce noise generated in a tire cavity of a vehicle in motion, technology related to sound-absorbing materials or sound-absorbing tires having various functions has been developed. With regard to the sound-absorbing material, a typical method is to reduce cavity noise generated inside the tire by attaching urethane foam to the inner surface of the tire.

In the related art, a tire sound-absorbing material having a sound-absorbing effect has been reported, and the material can be attached to the inner surface of the tire and have an open cell structure through reaction of a polyol and a diisocyanate.

Recently, a vehicle equipped with an emergency tire puncture repair kit, etc. has been released in the market instead of a spare tire/wheel for the purpose of reducing the weight and cost of vehicles. The emergency tire puncture repair kit specifically includes a liquid latex composition that may be injected into the puncture site in order to quickly seal the punctured part of the tire.

For example, a sealant composition for emergency tire puncture repair, which is convenient to use because the inlet at the puncture site is not blocked, and is useful for emergency repair of tires with superior sealing properties, coating properties, adhesive properties, and low-temperature stability, has been reported.

However, the sound-absorbing material attached to the inner surface of the tire absorbs liquid latex, causing a problem in that the latex is not sufficiently supplied to the puncture site. Briefly, it has become difficult to satisfy sealing performance with the latex capacity applied to general tires.

### SUMMARY

Provided is a sound-absorbing material for tires having an excellent cavity noise reduction effect and reduced liquid latex absorption properties.

The sound-absorbing material for tires may have liquid latex absorption properties.

The objects of the present disclosure are not limited to the foregoing. The objects of the present disclosure will be able to be clearly understood through the following description and to be realized by the means described in the claims and combinations thereof.

In an aspect, provided is a sound-absorbing material for a tire including an amount of about 90 to 98.5% by weight of polyurethane based on the total weight of the sound absorbing material.

The foam density of the sound-absorbing material may be about 30 kg/m³ to 35 kg/m³.

The tensile strength of the sound-absorbing material may be about 0.13 MPa or greater.

The elongation of the sound-absorbing material may be about 140% or greater.

The sound-absorbing material may have an amount of a latex solution absorbed therein may be about 3 g or less when the sound-absorbing material has a volume of about 32 cm³ and a foam density of about 30 kg/m 3 to 35 kg/m³.

The polyurethane may include a copolymer of a resin premixture and an isocyanate compound, and the resin premixture may include a polyol, a crosslinking agent, a catalyst, and a foaming agent.

A term “isocyanate compound” as sued herein refers to a compound having one or more isocyanate (e.g., —N═C═O) groups, preferably, two or more isocyanate groups. In certain embodiments, the isocyanate compound may have two or more terminal isocyanate group so is represented as O═C═N—R—N═C═O (wherein R is a hydrocarbon, e.g., alkyl, cycloalkyl, or aryl), which is reactive to epoxide and/or polyol.

A term “foaming agent” as used herein refers to a material that facilitates producing or itself produces a foam, gaseous product or by-product, or bubbles as being added in a composition or in a mixture, e.g., by chemical reaction therein. Exemplary foaming agent may include a surfactant or a blowing agent, and non-limiting examples include azodicarbonamide, activated azodicarbonamide, 5-phenyltetrazole, sodium bicarbonate, butane, pentane, neopentane, heptane, isoheptane, benzene, toluene, methyl chloride, trichloroethylene, dichloroethane, methylene chloride, trichlorofluoromethane, Freon 11, Freon 12, Freon 13, Freon 113, Freon 114, and monofluorotrichloromethane (R-11).

The isocyanate compound may include one or more selected from the group consisting of methylene diisocyanate (MDI), toluene diisocyanate (TDI), and hexamethylene diisocyanate (HDI).

The polyol may include one or more selected from the group consisting of a trifunctional polyol, and a difunctional polyol.

The crosslinking agent may include one or more selected from the group consisting of ethylene glycol, propylene glycol, 1,4-butanediol, hexamethylenediamine, m-phenylenediamine, glycerin, trimethylol propane, pentaerythritol, and oxypropylated ethylene diamine.

The catalyst may include one or more selected from the group consisting of dimethylcyclohexylamine (DMCHA), tetramethylenediamine (TMHDA), pentamethylene diethylene diamine (PMDETA), stannous octoate, stannous oleate, dibutyltin diacetate, dibutyltin dilaurate, and potassium octoate.

The foaming agent may include one or more selected from the group consisting of azodicarbonamide, activated azodicarbonamide, 5-phenyltetrazole, sodium bicarbonate, butane, pentane, neopentane, heptane, isoheptane, benzene, toluene, methyl chloride, trichloroethylene, dichloroethane, methylene chloride, trichlorofluoromethane, Freon 11, Freon 12, Freon 13, Freon 113, Freon 114, and monofluorotrichloromethane (R-11).

The resin premixture may include 100 parts by weight of the polyol, about 0.5 parts by weight to 10 parts by weight of the crosslinking agent, about 0.1 parts by weight to 10 parts by weight of the foaming agent, and about 0.5 parts by weight to 5 parts by weight of carbon black.

The mass ratio of the resin premixture and the isocyanate compound may be about 80:20 to 65:35.

In an aspect, provided is a tire for a vehicle including an inner liner and the sound-absorbing material as described herein attached to the inner surface of the inner liner.

Also provided is a vehicle that includes the tire as described herein.

Other aspects of the invention are disclosed infra.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows an exemplary tire according to an exemplary embodiment of the present disclosure;

FIG. 2 shows an exemplary sound-absorbing material attached to an inner surface of an exemplary tire according to an exemplary embodiment of the present disclosure;

FIG. 3 shows an amount of latex that is absorbed in the sound-absorbing material depending on density;

FIG. 4 shows an exemplary process of compressing the sound-absorbing material according to an exemplary embodiment of the present disclosure; and

FIG. 5 shows a change in rebound resilience of the sound-absorbing material.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In an aspect, provided is a sound-absorbing material for tires having an excellent cavity noise reduction effect and capable of optimizing the rate of absorption of liquid latex.

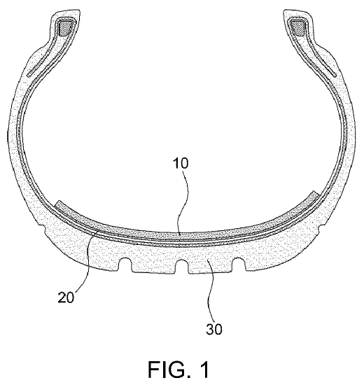

FIG. 1 shows an exemplary tire according to an exemplary embodiment of the present disclosure. With reference thereto, the tire may include an inner liner 20 and a sound-absorbing material 10 attached to the inner surface thereof.

The sound-absorbing material may include a polyurethane and an additive. Preferably, the sound-absorbing material of the present disclosure includes an amount of about 90 to 98.5% by weight of the polyurethane, or particularly of about 96.3 to 98.3% by weight of the polyurethane based on the total weight of the sound-absorbing material.

The polyurethane may result from polymerization of a resin premixture and an isocyanate compound.

The resin premixture may include a polyol, a crosslinking agent, a catalyst, and a foaming agent.

The isocyanate compound may include one or more selected from the group consisting of methylene diisocyanate (MDI), toluene diisocyanate (TDI), and hexamethylene diisocyanate (HDI).

The polyol may have a molecular weight of about 3,000 g/mol to 8,000 g/mol. Also, the polyol may include one or more selected from the group consisting of a trifunctional polyol and a difunctional polyol.

The trifunctional polyol may be prepared using an initiator such as glycerin, trimethylolpropane, triethanolamine, and the like.

The difunctional polyol may be prepared using an initiator such as ethylene glycol, diethylene glycol, and the like.

The crosslinking agent may include at least one selected from the group consisting of diol, diamine, triol, tetraol, and combinations thereof.

Examples of the diol may include ethylene glycol, propylene glycol, 1,4-butanediol, and the like.

Examples of the diamine may include hexamethylenediamine, m-phenylenediamine, and the like.

Examples of the triol may include glycerin, trimethylolpropane, and the like.

Examples of the tetraol may include pentaerythritol, oxypropylated ethylene diamine, and the like.

The catalyst may include a tertiary amine and/or an organometallic catalyst.

Examples of the tertiary amine may include dimethylcyclohexylamine (DMCHA), tetramethylenediamine (TMHDA), pentamethylene diethylene diamine (PMDETA), and the like.

Examples of the organometallic catalyst may include stannous octoate, stannous oleate, dibutyltin diacetate, dibutyltin dilaurate, potassium octoate, and the like.

The foaming agent may include a chemical foaming agent and/or a physical foaming agent.

Examples of the chemical foaming agent may include azodicarbonamide, activated azodicarbonamide, 5-phenyltetrazole, sodium bicarbonate, and the like.

Examples of the physical foaming agent may include butane, pentane, neopentane, heptane, isoheptane, benzene, toluene, methyl chloride, trichlorethylene, dichloroethane, methylene chloride, trichlorofluoromethane, Freon 11, Freon 12, Freon 13, Freon 113, Freon 114, monofluorotrichloromethane (R-11), and the like.

Examples of the additive may include a fireproofing agent, a flame retardant, carbon black, and the like, which may vary depending on the purpose of preparation. For example, the resin premixture may include 100 parts by weight of the polyol, about 0.5 parts by weight to 10 parts by weight of the crosslinking agent, about 0.1 parts by weight to 10 parts by weight of the foaming agent, and about 0.5 parts by weight to 5 parts by weight of the carbon black.

The mass ratio of the resin premixture and the isocyanate compound may be about 80:20 to 65:35.

The foam density of the sound-absorbing material may be determined depending on the amount of polyurethane, and the density thus determined may be about 29 to 38 kg/m³, or particularly about 30 to 35 kg/m³.

The tensile strength of the sound-absorbing material may be about 0.13 MPa or greater.

The elongation of the sound-absorbing material may be about 130% or greater, or particularly about 140% or greater.

The elastic modulus of the sound-absorbing material may be about 0.01 to 0.10, or particularly about 0.01 to 0.05.

### EXAMPLE

A better understanding of the present disclosure may be obtained through the following examples. These examples are merely set forth to illustrate the present disclosure and are not to be construed as limiting the scope of the present disclosure.

Preparation Examples

14 sound-absorbing materials were prepared by adjusting density, elongation, and tensile strength as shown in Table 1 below. The size of each sound-absorbing material was 4 cm×4 cm ×2 cm

TABLE 1

| Example | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| Density | 35 | 26 | 25 | 23 | 21 | 19 | 23 | 26 | 27 | 25 | 28 | 28 | 31 | 33 |
| Elongation | 386 | 195 | 130 | 135 | 135 | 140 | 180 | 195 | 105 | 100 | 180 | 130 | 142 | 160 |
| Tensile | 0.22 | 0.11 | 0.1 | 0.10 | 0.10 | 0.10 | 0.16 | 0.13 | 0.13 | 0.17 | 0.14 | 0.14 | 0.14 | 0.12 |
| strength | | | | | | | | | | | | | | |

In Table 1, the unit of density is kg/m³, the unit of elongation is %, and the unit of tensile strength is MPa.

Test Example 1 (Evaluation of Adhesion)

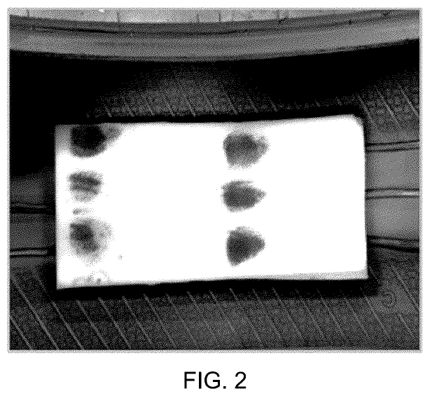

Each of the 14 sound-absorbing materials prepared in Preparation Examples was seated on the inner surface of the tire as shown in FIG. 2 and then adhered to the tire using an adhesive (silicone glue, Henkel LOCTITE SI5930FI).

The 14 sound-absorbing materials were subjected to load durability evaluation, after which detachment of the adhesive and whether the sound-absorbing material was damaged or not were observed, and the results thereof are shown in Table 2 below.

For load durability evaluation, a tire durability tester was used. Specifically, a load of 670 kg was applied, the tire was rotated at a speed of 120 kph, and durability was evaluated for 120 hours.

TABLE 2

| Example | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| Damage to | Not | Dam- | Dam- | Dam- | Dam- | Dam- | Dam- | Dam- | Dam- | Dam- | Dam- | Dam- | Not | Dam- |
| sound- | dam- | aged | aged | aged | aged | aged | aged | aged | aged | aged | aged | aged | dam- | aged |
| absorbing | aged | | | | | | | | | | | | aged | |
| material | | | | | | | | | | | | | | |

Test Example 2 (Evaluation of Liquid Latex Absorption)

The sound-absorbing materials were prepared by adjusting the density to 26 kg/m³, 30 kg/m³, 32 kg/m³, and 35 kg/m³, and the amount of liquid latex that was absorbed was measured. The amount of liquid latex that was absorbed in the sound-absorbing material was evaluated as follows.
1. Preparation of three samples having different densities with a size of 4 cm×4 cm×2 cm and measurement of weight thereof: (A)
2. Measurement of weight of each sample after complete immersion in TMK solution for 5 minutes: (B)
3. Measurement of the amount of TMK solution that was absorbed per sample: (B)-(A)
4. Calculation of the absorbed amount converted from TMK per sound-absorbing tire*: (C)
* Volume of sound-absorbing tire×TMK absorption test sample/volume of test sample

The elongation and tensile strength of each of the sound-absorbing materials are shown in Table 3 below. The results of measurement of the amount of liquid latex that was absorbed are shown in FIG. 2.

TABLE 3

| | | | | |
|---|---|---|---|---|
| Density (kg/m³) | 26 | 30 | 32 | 35 |
| Elongation (%) | 110 | 140 | 155 | 150 |
| Tensile strength (MPa) | 0.12 | 0.14 | 0.16 | 0.20 |

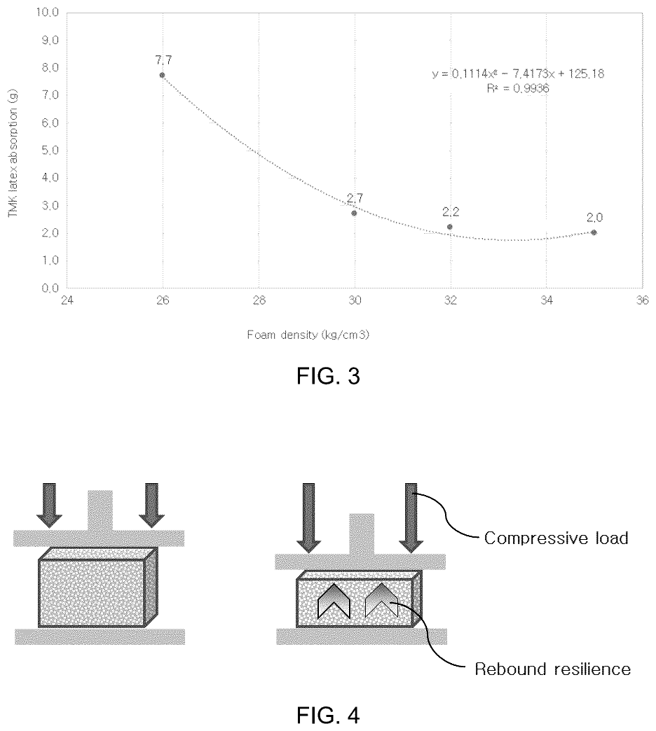

As shown in FIG. 3, in general, the less the foam density, the greater the amount of latex that was absorbed. However, when the density was about 32 kg/m³ or greater, the absorbed amount was converged to a similar level despite the increase in the foam density.

Test Example 3 (Measurement of Elastic Modulus)

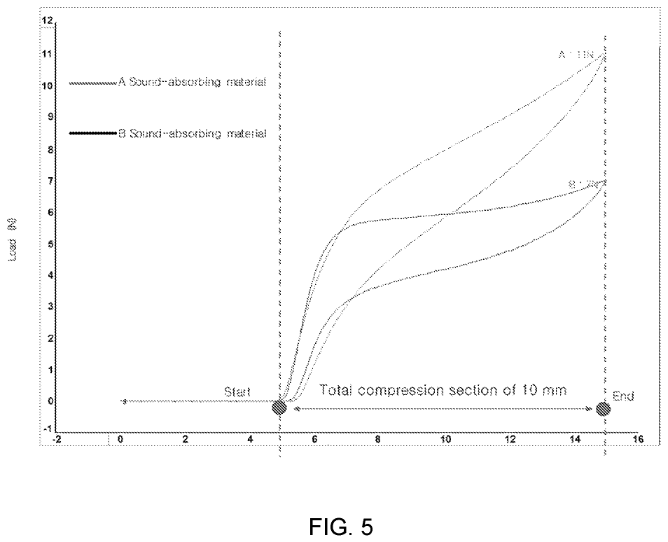

The sound-absorbing materials (5 cm×5 cm×2.5 cm) were prepared and then compressed (compression rate of 5 cm/min, compression displacement of 10 mm) as shown in FIG. 4, after which compressive force was measured, and the results thereof are shown in FIG. 5.

As shown in FIG. 5, the compressive force of the sound-absorbing material A was measured to be 11 N and the compressive force of the sound-absorbing material B was measured to be 7 N.

The tensile strength and elongation of the sound-absorbing material A and the sound-absorbing material B are shown in Table 4 below.

TABLE 4

| | Sound-absorbing | Sound-absorbing |
|---|---|---|
| Items | material A | material B |
| Foam density (kg/m³) | 31.8 | 32.4 |
| Tensile strength (kg/cm²) | 1.6 | 1.8 |
| Elongation (%) | 155 | 174 |
| Tear strength (N/cm) | 6.1 | 9.3 |

The elastic modulus was calculated as shown in Table 5 below using the compressive force measured above.

TABLE 5

| | Sound-absorbing | Sound-absorbing |
|---|---|---|
| Items | material A | material B |
| Compressive force (N) | 11 | 7 |
| Elastic modulus (MPa) | 0.011 | 0.007 |

Elastic modulus = compressive stress/strain
Compressive stress = compressive force/cross-sectional area of sound-absorbing material
Strain = compression length/length of sound-absorbing material

Test Example 4 (Measurement of Cavity Noise Reduction)

The extent of cavity noise reduction of the sound-absorbing material A and the sound-absorbing material B of Test Example 3 was measured. A microphone was mounted on all tires and the noise level in each frequency range was measured. The results thereof are shown in Tables 6 and 7 below.

TABLE 6
Actual vehicle NVH measurement result with two types of sound-
absorbing materials (sound-absorbing material A and sound-
absorbing material B) attached to all-season tires

| | Driver Right Ear (RMS, dB(A)) | | | | | |
|---|---|---|---|---|---|---|
| | Over- | Boom- | | Cavity | Rum- | Pat- |
| Classification | all | ing | Cavity | (Peak) | ble | tern |
| Reference | 64.3 | 58.9 | 60.6 | 51.8 | 58.7 | 58 |
| (no attachment of | | | | | | |
| sound-absorbing | | | | | | |
| material) | | | | | | |
| Attachment of sound- | −2.0 | −0.7 | −5.5 | −7.0 | −0.2 | −0.3 |
| absorbing material B | | | | | | |
| (reduction compared to | | | | | | |
| reference) | | | | | | |
| Attachment of sound- | −2.0 | −0.6 | −4.8 | −5.8 | −0.7 | −0.9 |
| absorbing material A | | | | | | |
| (reduction compared to | | | | | | |
| reference) | | | | | | |

TABLE 7
Actual vehicle NVH measurement result with two types of
sound-absorbing materials (sound-absorbing material A
and sound-absorbing material B) attached to summer tires

| | Driver Right Ear (RMS, dB(A)) | | | | | |
|---|---|---|---|---|---|---|
| | Over- | Boom- | | Cavity | Rum- | Pat- |
| Classification | all | ing | Cavity | (Peak) | ble | tern |
| Reference | 66.1 | 61.3 | 62.3 | 53.2 | 60.2 | 59.3 |
| (no attachment of | | | | | | |
| sound-absorbing | | | | | | |
| material) | | | | | | |
| Attachment of sound- | −2.6 | −1.9 | −5.7 | −6.0 | −0.6 | −1.0 |
| absorbing material B | | | | | | |
| (reduction compared to | | | | | | |
| reference) | | | | | | |
| Attachment of sound- | −2.8 | −1.9 | −4.9 | −5.6 | −1.6 | −1.7 |
| absorbing material A | | | | | | |
| (reduction compared to | | | | | | |
| reference) | | | | | | |

As is apparent from the above description, according to various exemplary embodiments of the present disclosure, it is possible to provide a sound-absorbing material for tires having an excellent cavity noise reduction effect and reduced liquid latex absorption properties.

According to various exemplary embodiments of the present disclosure, it is possible to provide a sound-absorbing material for tires in which liquid latex absorption properties are identified depending on the properties of the sound-absorbing material.

The effects of the present disclosure are not limited to the above-mentioned effects. It should be understood that the effects of the present disclosure include all effects that can be inferred from the description of the present disclosure.

Although the test examples and examples of the present disclosure have been described in detail above, the scope of the present disclosure is not limited to such test examples and examples. Various modifications and improvements by those skilled in the art using the basic concept of the present disclosure as defined in the following claims are also within the scope of the present disclosure.

What is claimed is:

1. A sound-absorbing material for a tire, comprising an amount of about 90 to 98.5% by weight of a polyurethane based on the total weight of the sound-absorbing material.

2. The sound-absorbing material of claim 1, wherein a foam density of the sound-absorbing material is about 30 kg/m³ to 35 kg/m³.

3. The sound-absorbing material of claim 1, wherein a tensile strength of the sound-absorbing material is about 0.13 MPa or greater.

4. The sound-absorbing material of claim 1, wherein an elongation of the sound-absorbing material is about 140% or greater.

5. The sound-absorbing material of claim 1, wherein the sound-absorbing material has an amount of a latex solution absorbed therein is about 3 g or less when the sound-absorbing material has a volume of 32 cm³ and a foam density of about 30 kg/m³ to 35 kg/m³.

6. The sound-absorbing material of claim 1, wherein:
the polyurethane comprises a copolymer of a resin premixture and an isocyanate compound,
the resin premixture comprises a polyol, a crosslinking agent, a catalyst, and a foaming agent,
the isocyanate compound comprises methylene diisocyanate (MDI), toluene diisocyanate (TDI), hexamethylene diisocyanate (HDI), or any combination thereof, the polyol comprises a trifunctional polyol, a difunctional polyol, or any combination thereof,
the crosslinking agent comprises ethylene glycol, propylene glycol, 1,4-butanediol, hexamethylenediamine, m-phenylenediamine, glycerin, trimethylol propane, pentaerythritol, oxypropylated ethylene diamine, or any combination thereof,
the catalyst comprises dimethylcyclohexylamine (DMCHA), tetramethylenediamine (TMHDA), pentamethylene diethylene diamine (PMDETA), stannous octoate, stannous oleate, dibutyltin diacetate, dibutyltin dilaurate, potassium octoate, or any combination thereof, and
the foaming agent comprises azodicarbonamide, activated azodicarbonamide, 5-phenyltetrazole, sodium bicarbonate, butane, pentane, neopentane, heptane, isoheptane, benzene, toluene, methyl chloride, trichloroethylene, dichloroethane, methylene chloride, trichlorofluoromethane, Freon 11, Freon 12, Freon 13, Freon 113, Freon 114, monofluorotrichloromethane (R-11), or any combination thereof.

7. The sound-absorbing material of claim 6, wherein the resin premixture comprises 100 parts by weight of the polyol, about 0.5 parts by weight to 10 parts by weight of the crosslinking agent, about 0.1 parts by weight to 10 parts by weight of the foaming agent, and about 0.5 parts by weight to 5 parts by weight of carbon black.

8. The sound-absorbing material of claim 6, wherein a mass ratio of the resin premixture and the isocyanate compound is about 80:20 to 65:35.

9. A tire comprising:
an inner liner; and
a sound-absorbing material of claim 1 attached to an inner surface of the inner liner.

10. A vehicle comprising a tire of claim 9.
